(19) United States
(12) Patent Application Publication
(10) Pub. No.: US 2008/0290851 A1
(43) Pub. Date: Nov. 27, 2008

(54) POWER SUPPLY

(75) Inventors: Hiroki Akashi, Osaka (JP); Takuya Ishii, Osaka (JP)

Correspondence Address: RATNERPRESTIA, P.O. BOX 980, VALLEY FORGE, PA, 19482, US

(73) Assignee: Matsushita Electric Industrial Co., Ltd., Osaka (JP)

(21) Appl. No.: 12/112,087

(22) Filed: Apr. 30, 2008

(30) Foreign Application Priority Data
May 23, 2007 (JP) 2007-136616

(51) Int. Cl. G05F 1/46

(52) U.S. Cl. 323/283

(57) ABSTRACT

A power supply has a soft-start function capable of raising its output DC voltage without generating overshoot even when its load condition is set light at the start-up. The power supply comprises an error amplifier for outputting an error signal corresponding to the error between the output DC voltage and the target value thereof, a control section for adjusting power to be supplied to the load on the basis of this error signal, and a limiting circuit for limiting the voltage of the error signal to a predetermined level for a predetermined time after the output DC voltage at the start-up exceeds a predetermined value being set less than the target value.

### BACKGROUND OF THE INVENTION

The present invention relates to a power supply to which a DC voltage is input from a DC power supply, such as a battery, and from which a controlled DC voltage is output, more particularly, to a soft-start technology in the power supply.

Power conversion systems, such as a series regulator system comprising a voltage control device connected in series with a load and a switching regulator system comprising switching devices, are used for power supplies. In order that a power supply supplies a stable output DC voltage to a load, both the systems are common in that its output DC voltage is detected and fed back. In a power supply, its supply power increases when its output DC voltage is lower than a target value and decreases when the output DC voltage is higher than the target value. For this reason, at the start-up of the power supply, during which the output DC voltage is going to reach the target value, the supply power is increased to the limit of the capacity. As a result, there is a problem that inrush current is generated from the input DC power supply of the power supply. Furthermore, since the power supply is configured such that the supply power is decreased after the output DC voltage exceeds the target value, there is a problem of generating overshoot that supplies excessive power exceeding the target value to the load.

The soft-start technology for limiting the supply power at the start-up is used to suppress inrush current generated at the start-up. FIG. 11 is a circuit diagram showing the configuration of a conventional power supply having a soft-start function and disclosed in Japanese Patent Application Laid-Open Publication No. 2005-269838.

Referring to FIG. 11, an input DC power supply 201, such as a battery, generates and outputs an input DC voltage Vi. A voltage conversion section, referred to as a step-down converter, comprises a switching transistor 202, a diode 203, an inductor 204 and an output capacitor 205. This voltage conversion section converts the input DC voltage Vi into an output DC voltage Vo and supplies the output DC voltage Vo from the output capacitor 205 to a load 206. A reference voltage supply 207 generates a reference voltage serving as the target of the output DC voltage Vo. An error amplifier 208 amplifies the difference voltage between the output DC voltage Vo and the reference voltage and outputs an error signal Ve. A comparator circuit 209 compares the output DC voltage Vo with a predetermined value. This predetermined value is set at 95% of the reference voltage, for example.

A PWM circuit 210 generates and outputs a drive pulse signal having a pulse width based on the error signal Ve input thereto. The switching transistor 202 repeats ON/OFF operation according to the drive pulse signal output from the PWM circuit 210. Since the switching transistor 202 repeats ON/OFF operation, the input DC voltage Vi is chopped and rectified using the diode 203, and smoothed using the inductor 204 and the output capacitor 205, whereby the output DC voltage Vo is supplied to the load 206. The output DC voltage Vo becomes high when the ratio (hereinafter referred to as the “duty ratio”) of the ON time in the switching cycle of the switching transistor 202 is large. The output of the comparator circuit 209 is input to a clamp circuit 211. During a period in which the output DC voltage Vo does not reach the predetermined value, the clamp circuit 211 suppresses the error signal Ve from rising, thereby limiting the error signal Ve to a predetermined value.

In addition, referring to FIG. 11, the voltage of the error signal Ve generated by the error amplifier 208 rises when the output DC voltage Vo is lower than the reference voltage, and lowers when the output DC voltage Vo is higher than the reference voltage. During the normal operation time, the clamp circuit 211 does not operate, and the error signal Ve generated by the error amplifier 208 is directly input to the PWM circuit 210. The pulse width of the drive pulse signal output from the PWM circuit 210 is larger as the voltage of the error signal Ve is higher. In other words, when the output DC voltage Vo is lower than the reference voltage, the voltage of the error signal Ve rises, the duty ratio of the switching transistor 202 becomes larger, and the output DC voltage Vo becomes higher. Conversely, when the output DC voltage Vo is higher than the reference voltage, the voltage of the error signal Ve lowers, the duty ratio of the switching transistor 202 becomes smaller, and the output DC voltage Vo becomes lower. By virtue of this feedback operation, the output DC voltage Vo is controlled so as to become equal to the reference voltage.

On the other hand, at the start-up, since the output DC voltage Vo does not reach the predetermined value (95% of the reference voltage), the clamp circuit 211 operates to limit the voltage of the error signal Ve input to the PWM circuit 210 to a clamp voltage. In reality, since the clamp voltage being lower than the voltage of the error signal Ve having a high potential is input to the PWM circuit 210, the duty ratio of the switching transistor 202 becomes small, and the supply power is limited. As a result, the generation of inrush current is prevented in the conventional power supply. When the output DC voltage Vo reaches the predetermined value (95% of the reference voltage) in the power supply, the limitation of the supply power is released, and the operation shifts to the normal operation in which the output DC voltage Vo is adjusted to the reference voltage.

However, although inrush current can be limited in the power supply having the conventional soft-start function and configured as described above, when the limitation of the supply power is released after the output DC voltage Vo reaches the preset voltage, overshoot is generated in the output DC voltage Vo in the case that the load 206 is light. To solve this problem, there is a method in which the limitation of the supply power to limit inrush current is continued after the start-up. However, in the case that the limitation level of the supply power for suppressing overshoot is lower than the limitation level of the supply power for limiting inrush current, this method has a problem of being unable to sufficiently suppress overshoot.

An object of the present invention is to provide a power supply capable of securely carrying out soft-start operation, more particularly, to provide a power supply having a soft-start function capable of raising the output DC voltage without generating overshoot even when the load is set light at the start-up.

### SUMMARY OF THE INVENTION

To attain the above-mentioned object, a power supply according to a first aspect of the present invention, for converting an input DC voltage into an output DC voltage and supplying power to a load, comprises:

an error amplifier for outputting an error signal corresponding to the error between the output DC voltage and the target value thereof,

a control section for adjusting power to be supplied to the load on the basis of the error signal, and

a limiting circuit for limiting the voltage of the error signal to a predetermined level for a predetermined time after the output DC voltage at the start-up exceeds a predetermined value being set less than the target value.

With the power supply configured as described above, when the load condition is set light at the start-up, the output DC voltage can rise without generating overshoot.

The power supply according to a second aspect of the present invention may be configured such that the limiting circuit according to the first aspect limits the voltage of the error signal to a first predetermined level until the output DC voltage at the start-up reaches the predetermined value being set less than the target value, and limits the voltage of the error signal to a second predetermined level for a predetermined time after the output DC voltage at the start-up exceeds the predetermined value being set less than the target value.

The power supply according to a third aspect of the present invention may be configured such that the limiting circuit according to the second aspect comprises a comparator circuit for comparing the output DC voltage with the predetermined value being set less than the target value; a first clamp circuit for limiting the voltage of the error signal to a first predetermined level on the basis of the output of the comparator circuit until the output DC voltage at the start-up reaches the predetermined value being set less than the target value; and a second clamp circuit for limiting the voltage of the error signal to a second predetermined level for a predetermined time on the basis of the output of the comparator circuit after the output DC voltage at the start-up exceeds the predetermined value being set less than the target value.

The power supply according to a fourth aspect of the present invention may be configured such that the second clamp circuit according to the third aspect limits the voltage of the error signal to a second predetermined level on the basis of the output of the comparator circuit for a predetermined time after the output DC voltage at the start-up exceeds the predetermined value being set less than the target value, and releases the limitation to the second predetermined level when the error between the output DC voltage at the start-up and the target value becomes a reference voltage or less.

The power supply according to a fifth aspect of the present invention may be configured such that the limiting circuit according to the second aspect comprises a first comparator circuit for comparing the output DC voltage with a first value being set less than the target value; a second comparator circuit for comparing the output DC voltage with a second value that is set less than the target value and higher than the first value; a first clamp circuit for limiting the voltage of the error signal to a first predetermined level on the basis of the output of the first comparator circuit until the output DC voltage at the start-up reaches the first value being set less than the target value; and a second clamp circuit for limiting the voltage of the error signal to a second predetermined level for a predetermined time on the basis of the output of the first comparator circuit after the output DC voltage at the start-up exceeds the first value being set less than the target value, the limitation to the second predetermined level being released on the basis of the output of the second comparator circuit.

The power supply according to a sixth aspect of the present invention may be configured such that the predetermined time according to the first and second aspects is set at a period elapsed after the output DC voltage exceeds the predetermined value being set less than the target value and until the output DC voltage reaches the target value.

The power supply according to a seventh aspect of the present invention may be configured such that the control section according to the first to fifth aspects comprises a voltage conversion section having a switch, a rectifier and an inductor, and a PWM circuit for ON/OFF controlling the switch according to the error signal.

The power supply according to an eighth aspect of the present invention may be configured such that the PWM circuit according to the seventh aspect comprises a current detector for detecting the current flowing through the voltage conversion section, and a timing setting circuit for setting the ON/OFF timing of the switch on the basis of the output of the current detector and the error signal.

Since the present invention is configured so as to limit supply power immediately before the output DC voltage reaches the target value, it is possible to provide a power supply capable of securely suppressing output overshoot even at the start-up under light load.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1 is a circuit diagram showing the configuration of a power supply according to a first embodiment of the present invention;

FIGS. 2A to 2F are waveform diagrams showing the operation of the power supply according to the first embodiment at the start-up;

FIG. 3 is a circuit diagram showing the configuration of a power supply according to a second embodiment of the present invention;

FIGS. 4A to 4F are waveform diagrams showing the operation of the power supply according to the second embodiment at the start-up;

FIG. 5 is a circuit diagram showing the configuration of a power supply according to a third embodiment of the present invention;

FIGS. 6A to 6G are waveform diagrams showing the operation of the power supply according to the third embodiment at the start-up;

FIG. 7 is a circuit diagram showing the configuration of a power supply according to a fourth embodiment of the present invention;

FIG. 8 is a circuit diagram showing the configuration of a current detection circuit in the power supply according to the fourth embodiment;

FIG. 9 is a circuit diagram showing the configuration of a timer circuit in the power supply according to the fourth embodiment;

FIGS. 10A to 10G are waveform diagrams showing the operation of the power supply according to the fourth embodiment at the start-up; and

FIG. 11 is the circuit diagram showing the configuration of the conventional power supply.

It will be recognized that some or all of the Figures are schematic representations for purposes of illustration and do not necessarily depict the actual relative sizes or locations of the elements shown.

### DETAILED DESCRIPTION OF THE PREFERRED EMBODIMENTS

Preferred embodiments of a power supply according to the present invention will be described below referring to the accompanying drawings.

### First Embodiment

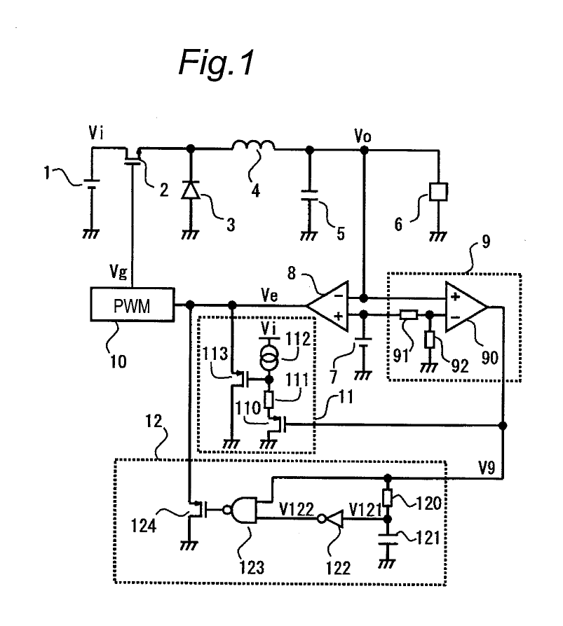

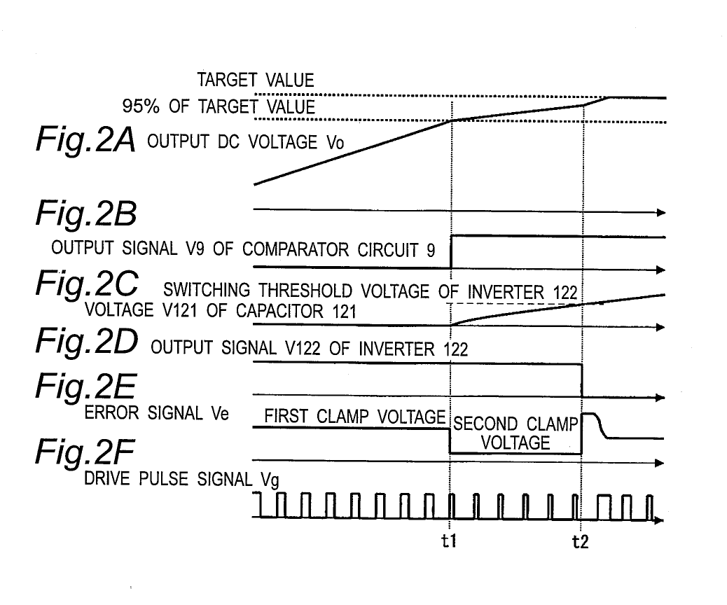

A power supply according to a first embodiment of the present invention will be described below referring to FIGS. 1 and 2. FIG. 1 is a circuit diagram showing the configuration of the power supply according to the first embodiment of the present invention. FIGS. 2A to 2F are waveform diagrams showing the operations of various sections of the power supply shown in FIG. 1 at the start-up thereof.

Referring to FIG. 1, an input DC power supply 1, such as a battery, generates and outputs an input DC voltage Vi. A voltage conversion section, referred to as a step-down converter, comprises a switching transistor 2, a diode 3, an inductor 4 and an output capacitor 5. This voltage conversion section converts the input DC voltage Vi into an output DC voltage Vo and supplies the output DC voltage Vo from the output capacitor 5 to a load 6. A reference voltage supply 7 generates a reference voltage serving as the target of the output DC voltage Vo. An error amplifier 8 amplifies the difference voltage between the output DC voltage Vo and the reference voltage and outputs an error signal Ve. A comparator circuit 9 comprises a comparator 90 and two resistors 91 and 92, and the comparator 90 compares the output DC voltage Vo with a predetermined value. The predetermined value that is compared using the comparator 90 is obtained by dividing the reference voltage using the resistors 91 and 92. The predetermined value is set at 95% of the reference voltage, for example. The error signal Ve is input to the PWM circuit 10, and the PWM circuit 10 outputs a drive pulse signal Vg having a pulse width based on the error signal Ve input thereto. The switching transistor 2 repeats ON/OFF operation according to the drive pulse signal Vg output from the PWM circuit 10. Since the switching transistor 2 repeats ON/OFF operation, the input DC voltage Vi is chopped and rectified using the diode 3, and smoothed using the inductor 4 and the output capacitor 5, whereby the output DC voltage Vo is supplied to the load 6. The output DC voltage Vo becomes high when the ratio (hereinafter referred to as the “duty ratio”) of the ON time in the switching cycle of the switching transistor 2 is large. In the power supply according to the first embodiment, the step-down converter comprising the switching transistor 2, the diode 3, the inductor 4 and the output capacitor 5, and the PWM circuit 10 constitute a control section.

A first clamp circuit 11 serving as a limiting circuit comprises a transistor 110 that is driven using the output signal of the comparator circuit 9, a resistor 111, a constant current supply 112 for supplying a constant current to this resistor 111 and a transistor 113 that is driven using the voltage generated at the connection point of the resistor 111 and the constant current supply 112. When the transistor 110 is ON, the addition voltage (Vt+Vr) of the source-gate voltage Vt of the transistor 110 and the constant voltage Vr generated across the resistor 111 is applied to the gate of the transistor 113, and the transistor 113 is turned ON. On the other hand, when the transistor 110 is OFF, the input voltage Vi is applied to the gate of the transistor 113, and the transistor 113 is turned OFF.

A second clamp circuit 12 serving as a limiting circuit comprises an integrating circuit comprising a resistor 120 and a capacitor 121 for integrating the output signal of the comparator circuit 9, an inverter 122 for inverting the output of the capacitor 121, a NAND circuit 123 for outputting the NAND of the output signal of the inverter 122 and the output signal of the comparator circuit 9, and a transistor 124 that is driven using the output of the NAND circuit 123.

Next, the operation of the power supply according to the first embodiment configured as described above will be described below. First, the operation of the power supply according to the first embodiment during the normal operation time will be described below.

Referring to FIG. 1, the voltage of the error signal Ve generated by the error amplifier 8 rises when the output DC voltage Vo is lower than the reference voltage, and lowers when the output DC voltage Vo is higher than the reference voltage. During the normal operation time, the first clamp circuit 11 and the second clamp circuit 12 do not operate, and the error signal Ve generated by the error amplifier 8 is directly input to the PWM circuit 10, as described later. The pulse width of the drive pulse signal Vg output from the PWM circuit 10 is larger as the voltage of the error signal Ve is higher. In other words, when the output DC voltage Vo is lower than the reference voltage, the voltage of the error signal Ve rises, the duty ratio of the switching transistor 2 becomes larger, and the output DC voltage Vo becomes higher.

Conversely, when the output DC voltage Vo is higher than the reference voltage, the voltage of the error signal Ve lowers, the duty ratio of the switching transistor 2 becomes smaller, and the output DC voltage Vo becomes lower. By virtue of this feedback operation, the output DC voltage Vo is controlled so as to become equal to the reference voltage. In the first clamp circuit 11, the transistor 110 is turned OFF using the H-level (high-level) output signal of the comparator circuit 9 that is input thereto, whereby the transistor 13 is also turned OFF. Furthermore, in the second clamp circuit 12, the capacitor 121 is charged using the H-level output signal of the comparator circuit 9 that is input thereto, and the inverter 122 outputs an L-level (low-level) signal. As a result, the NAND circuit 123 outputs an H-level signal, and the transistor 124 is turned OFF.

Next, the operation of the power supply at the start-up will be described below referring to FIGS. 2A to 2F. FIGS. 2A to 2F are waveform diagrams showing the operations of various sections of the power supply shown in FIG. 1 at the start-up thereof.

FIG. 2A shows the waveform of the output DC voltage Vo, FIG. 2B shows the waveform of the output signal V9 of the comparator circuit 9, FIG. 2C shows the waveform of the voltage of the capacitor 121 of the second clamp circuit 12, that is, the input signal V121 of the inverter 122. In addition, FIG. 2D shows the waveform of the output signal V122 of the inverter 122 of the second clamp circuit 12, FIG. 2E shows the waveform of the error signal Ve, and FIG. 2F shows the waveform of the drive pulse signal Vg, that is, the output of the PWM circuit 10 for driving the switching transistor 2.

First, at the start-up in which the output DC voltage Vo does not reach the predetermined value (95% of the reference voltage) that is less than the target value, the output signal V9 of the comparator circuit 9 is L level, the voltage of the error signal Ve input to the PWM circuit 10 is limited to the addition voltage (2Vt+Vr) of the source-gate voltage Vt of the transistor 110, the voltage Vr across the resistor 111 and the source-gate voltage Vt of the transistor 113 of the first clamp circuit 11. In reality, since the voltage of the error signal Ve rising to a high potential is limited to the first clamp voltage (2Vt+Vr) and input to the PWM circuit 10, the duty ratio of the switching transistor 2 becomes small, and the supply power is limited. As a result, the generation of inrush current can be prevented in the power supply according to the first embodiment. During this period, in the second clamp circuit 12, the NAND circuit 123 outputs an H-level signal by virtue of the L-level output signal of the comparator circuit 9 that is input thereto, and the transistor 124 is turned OFF. Since the capacitor 121 is discharged to L level, the output signal V122 of the inverter 122 is H level.

When the output DC voltage Vo reaches the predetermined value (95% of the reference voltage) at time t1 in FIGS. 2A to 2F, the output signal V9 of the comparator circuit 9 becomes H level, and the clamp limitation using the first clamp circuit 11 is released. At the same time, in the second clamp circuit 12, since the output signal V122 of the inverter 122 is H level and the output signal of the comparator circuit 9 becomes H level, the output of the NAND circuit 123 becomes L level. As a result, the transistor 124 is turned ON, and the voltage of the error signal Ve is limited to the source-gate voltage Vt of the transistor 124. Since the error signal Ve, the voltage of which is limited to the second clamp voltage (Vt) instead of the first clamp voltage (2Vt+Vr) as described above, is input to the PWM circuit 10, the duty ratio of the switching transistor 2 becomes further smaller, the rising speed of the output DC voltage Vo is further suppressed, and the generation of overshoot is prevented. This limitation continues until the charging of the capacitor 121 proceeds via the resistor 120 and the output of the inverter 122 is inverted to L level. At time t2 in FIGS. 2A to 2F, the input signal V121 of the inverter 122 rises above the threshold value at which the output signal V122 is switched from H level to L level, and the output signal V122 of the inverter 122 becomes L level. Hence, the output of the NAND circuit 123 becomes H level, and the transistor 124 is turned OFF. When the transistor 124 is turned OFF, the limitation using the error signal Ve, the voltage of which is limited to the second clamp voltage (Vt), is released, and the operation shifts to the normal operation in which the output DC voltage Vo is controlled to the reference voltage.

As described above, in the power supply according to the first embodiment, at the light-load start-up in which the output DC voltage Vo does not reach the predetermined value that is less than the target value, the voltage of the error signal Ve is limited to the first clamp voltage (2Vt+Vr), and the supply power is limited, whereby inrush current is prevented. Furthermore, for a predetermined period after the output DC voltage Vo has reached the predetermined value, the voltage of the error signal Ve is limited to the second clamp voltage (Vt), and the rising speed of the output DC voltage Vo is further suppressed. As a result, the generation of overshoot is prevented securely.

### Second Embodiment

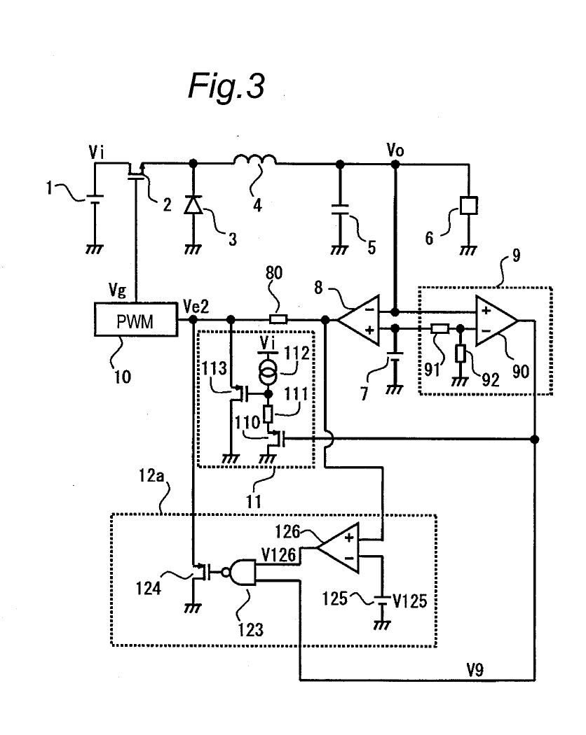

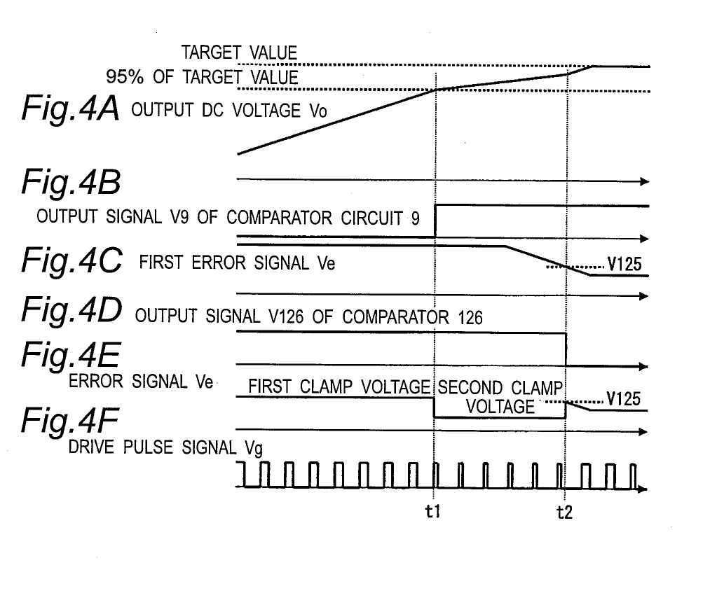

A power supply according to a second embodiment of the present invention will be described below referring to the accompanying FIGS. 3 and 4. FIG. 3 is a circuit diagram showing the configuration of the power supply according to the second embodiment of the present invention. FIGS. 4A to 4F are waveform diagrams showing the operations of various sections of the power supply shown in FIG. 3 at the start-up thereof. In the power supply according to the second embodiment shown in FIGS. 2A to 2F, the components having the same functions and configurations as those of the above-mentioned power supply according to the first embodiment are designated by the same numerals, and their descriptions are omitted. The power supply according to the second embodiment differs from the power supply according to the first embodiment in that a resistor 80 is connected to the output terminal of the error amplifier 8 and the output (Ve) of the error amplifier 8 is input as an input (Ve2) to the PWM circuit 10 via the resistor 80, and that the configuration of a second clamp circuit 12a serving as a limiting circuit differs from that of the second clamp circuit 12. The second clamp circuit 12a of the power supply according to the second embodiment is designated by numeral 12a so as to be distinguished from the second clamp circuit 12 according to the first embodiment shown in FIG. 1.

As shown in FIG. 3, the second clamp circuit 12a comprises a NAND circuit 123, a transistor 124, a voltage supply 125 and a comparator 126. The configurations of the NAND circuit 123 and the transistor 124 are similar to those of the NAND circuit 123 and the transistor 124 of the second clamp circuit 12 shown in FIG. 1. The comparator 126 compares the voltage of the first error signal Ve output from the error amplifier 8 with the voltage V125 of the voltage supply 125. The voltage V125 of the voltage supply 125 is set at a level slightly higher than the source-gate voltage Vt of the transistor 124.

Since the operation of the power supply according to the second embodiment configured as described above during the normal operation time is similar to that of the power supply according to the above-mentioned first embodiment, the description thereof is omitted herein.

Next, the operation of the power supply according to the second embodiment at the start-up will be described below referring to FIGS. 4A to 4F. FIGS. 4A to 4F are waveform diagrams showing the operations of various sections of the power supply according to the second embodiment shown in FIGS. 4A to 4F at the start-up.

FIG. 4A shows the waveform of the output DC voltage Vo, FIG. 4B shows the waveform of the output signal V9 of the comparator circuit 9, FIG. 4C shows the waveform of the first error signal Ve, FIG. 4D shows the waveform of the output signal V126 of the comparator 126, FIG. 4E shows the waveform of a second error signal Ve2 input to the PWM circuit 10, and FIG. 4F shows the waveform of the drive pulse signal Vg, that is, the output of the PWM circuit 10 for driving the switching transistor 2.

First, at the start-up in which the output DC voltage Vo does not reach the predetermined value (95% of the reference voltage), the first error signal Ve generated by the error amplifier 8 has a high potential. However, the output signal V9 of the comparator circuit 9 is L level, and the voltage of the second error signal Ve2 that is input to the PWM circuit 10 is limited to the addition voltage (2Vt+Vr) of the source-gate voltage Vt of the transistor 110, the voltage Vr across the resistor 111 and the source-gate voltage Vt of the transistor 113 of the first clamp circuit 11. Hence, the duty ratio of the switching transistor 2 becomes small, and the supply power is limited. As a result, the generation of inrush current can be prevented in the power supply according to the second embodiment. During this period, in the second clamp circuit 12a, since the voltage of the first error signal Ve is higher than the voltage V125 of the voltage supply 125, the output signal V126 of the comparator 126 is H level. Furthermore, since the output signal V9 of the comparator circuit 9 is L level, the NAND circuit 123 outputs an H-level signal and the transistor 124 is turned OFF.

When the output DC voltage Vo reaches the predetermined value (95% of the reference voltage) at time t1 in FIGS. 4A to 4F, the output signal V9 of the comparator circuit 9 becomes H level, and the clamp limitation using the first clamp circuit 11 is released. At the same time, in the second clamp circuit 12a, since the comparator 126 outputs an H-level signal and the output signal V9 of the comparator circuit 9 becomes H level, the output of the NAND circuit 123 becomes L level. As a result, the transistor 124 is turned ON, and the voltage of the second error signal Ve2 is limited to the source-gate voltage Vt of the transistor 124. Since the second error signal Ve2, the voltage of which is limited to the second clamp voltage (Vt) instead of the first clamp voltage (2Vt+Vr) as described above, is input to the PWM circuit 10, the duty ratio of the switching transistor 2 becomes further smaller. As a result, the rising speed of the output DC voltage Vo of the power supply according to the second embodiment is suppressed, and the generation of overshoot is prevented. The output DC voltage Vo soon reaches the reference voltage of the reference voltage supply 7, that is, the target value, and the voltage of the first error signal Ve lowers. Since it is premised that the load 6 at the start-up is light, the voltage of the first error signal Ve lowers to a level lower than the voltage V125 of the voltage supply 125. When the voltage of the first error signal Ve lowers to a level lower than the voltage V125 of the voltage supply 125 at time t2 in FIGS. 4A to 4F, the output signal V126 of the comparator 126 is inverted to L level. As a result, the output of the NAND circuit 123 becomes H level, and the transistor 124 is turned OFF, whereby the limitation state in which the voltage of the second error signal Ve2 is limited to the second clamp voltage (Vt) is released. Then, in the power supply according to the second embodiment, the operation shifts to the normal operation in which the output DC voltage Vo is controlled to the reference voltage.

As described above, in the power supply according to the second embodiment, the resistor 80 is provided so that the output level (Ve) from the error amplifier 8 is separated from the input level (Ve2) to the PWM circuit 10. Furthermore, a judgment as to whether the output DC voltage Vo has reached the target value is made depending on the output level from the error amplifier 8, whereby it becomes possible to set the limitation period using the second clamp voltage. Since the first clamp circuit 11 and the second clamp circuit 12 do not carry out clamp operation during the normal operation time, the output level from the error amplifier 8 is equal to the input level to the PWM circuit 10.

As described above, in the power supply according to the second embodiment, at the light-load start-up in which the output DC voltage Vo does not reach the predetermined value that is less than the target value, the voltage of the second error signal Ve2 is limited to the first clamp voltage (2Vt+Vr), and the supply power is limited, whereby the generation of inrush current is prevented. Furthermore, for a predetermined period after the output DC voltage Vo has reached the predetermined value, the voltage of the second error signal Ve2 is limited to the second clamp voltage (Vt), and the rising speed of the output DC voltage Vo is further suppressed. As a result, the generation of overshoot is prevented securely.

### Third Embodiment

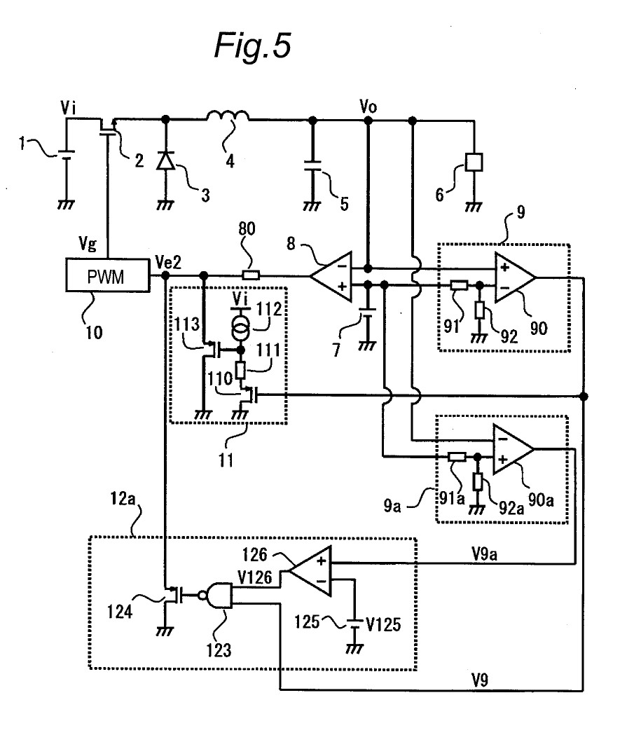

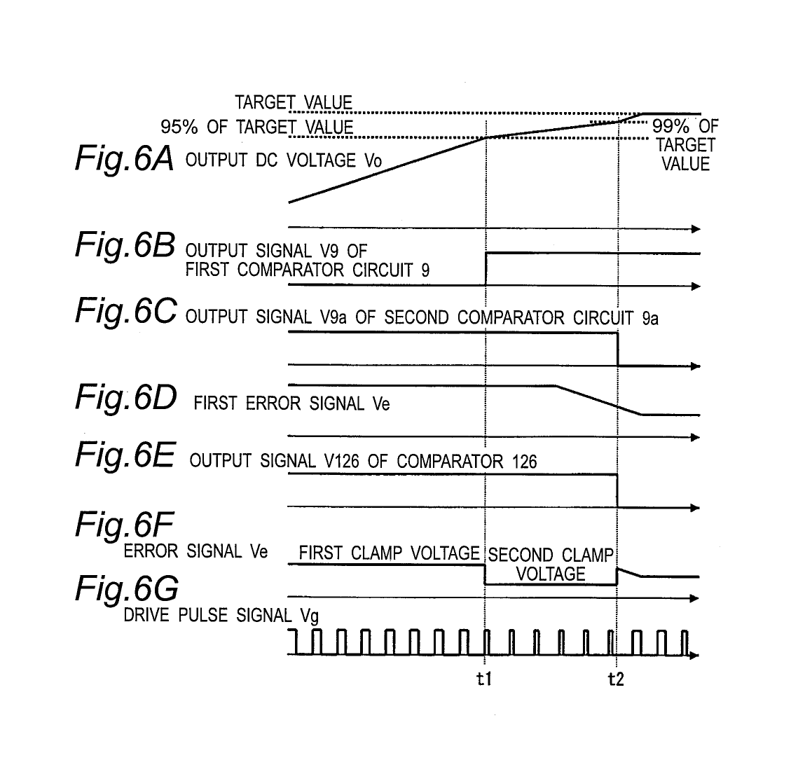

A power supply according to a third embodiment of the present invention will be described below referring to the accompanying FIGS. 5 and 6. FIG. 5 is a circuit diagram showing the configuration of the power supply according to the third embodiment of the present invention. FIGS. 6A to 6G are waveform diagrams showing the operations of various sections of the power supply shown in FIG. 5 at the start-up thereof. In the power supply according to the third embodiment, the components having the same functions and configurations as those of the above-mentioned power supplies according to the first and second embodiments are designated by the same numerals, and their descriptions are omitted. The power supply according to the third embodiment differs from the power supply according to the first embodiment in that a second comparator circuit 9a is provided additionally. In the power supply according to the third embodiment, the output of the second comparator circuit 9a is input to the non-inverting input terminal of the comparator 126 of the second clamp circuit 12a.

The power supply according to the third embodiment is provided with a first comparator circuit 9, the output signal of which is input to the first clamp circuit 11 and the second clamp circuit 12a, and the second comparator circuit 9a, the output signal of which is input to the second clamp circuit 12a. The configuration of the first comparator circuit 9 according to the third embodiment is substantially the same as that of the comparator circuit 9 according to the first embodiment. The first comparator circuit 9 is provided with a comparator 90 and two resistors 91 and 92, and the comparator 90 compares the output DC voltage Vo with a first predetermined value. The first predetermined value that is compared by the comparator 90 is formed by dividing the reference voltage using the resistors 91 and 92. The first predetermined value is formed so as to be 95% of the reference voltage, for example. The second comparator circuit 9a in the power supply according to the third embodiment is provided with a comparator 90a and two resistors 91a and 92a, and the comparator 90a compares the output DC voltage Vo with a second predetermined value. The second predetermined value that is compared by the comparator 90a is formed by dividing the reference voltage using the resistors 91a and 92a. The second predetermined value is formed so as to be 99% of the reference voltage, for example.

Since the operation of the power supply according to the third embodiment configured as described above during the normal operation time is similar to that of the power supply according to the above-mentioned first embodiment, the description thereof is omitted herein.

Next, the operation of the power supply according to the third embodiment at the start-up will be described below referring to FIGS. 6A to 6G. FIGS. 6A to 6G are waveform diagrams showing the operations of various sections of the power supply according to the third embodiment shown in FIGS. 4A to 4F at the start-up.

FIG. 6A shows the waveform of the output DC voltage Vo, FIG. 6B shows the waveform of the output signal V9 of the first comparator circuit 9, FIG. 6C shows the waveform of the output signal V9a of the second comparator circuit 9a, FIG. 6D shows the waveform of the first error signal Ve output from the error amplifier 8, FIG. 6E shows the waveform of the output signal V126 of the comparator 126, FIG. 6F shows the waveform of the second error signal Ve2 input to the PWM circuit 10, and FIG. 6G shows the waveform of the drive pulse signal Vg, that is, the output of the PWM circuit 10 for driving the switching transistor 2.

First, at the start-up in which the output DC voltage Vo does not reach the first predetermined value (95% of the reference voltage), the first error signal Ve generated by the error amplifier 8 has a high potential, and the output signal V9 of the first comparator circuit 9 is L level. Hence, the voltage of the second error signal Ve2 that is input to the PWM circuit 10 is limited to the addition voltage (2Vt+Vr) of the source-gate voltage Vt of the transistor 110, the voltage Vr across the resistor 111 and the source-gate voltage Vt of the transistor 113 of the first clamp circuit 11. Hence, the duty ratio of the switching transistor 2 becomes small, and the supply power is limited. As a result, the generation of inrush current can be prevented in the power supply according to the third embodiment. During this period, in the second clamp circuit 12a, since the output DC voltage Vo is lower than the second predetermined value (99% of the reference voltage), the output signal V9a of the second comparator circuit 9a is H level, the output signal V126 of the comparator 126 is H level, and the output signal V9 of the first comparator circuit 9 is L level, the NAND circuit 123 outputs an H-level signal. Hence, the transistor 124 is turned OFF.

When the output DC voltage Vo reaches the first predetermined value (95% of the reference voltage) that is less than the target value at time t1 in FIGS. 6A to 6G, the output signal V9 of the first comparator circuit 9 becomes H level, and the clamp limitation using the first clamp circuit 11 is released. At the same time, in the second clamp circuit 12a, since the comparator 126 outputs an H-level signal and the output signal V9 of the first comparator circuit 9 becomes H level, the output of the NAND circuit 123 becomes L level. As a result, the transistor 124 is turned ON, and the voltage of the second error signal Ve2 is limited to the source-gate voltage Vt of the transistor 124. The second error signal Ve2, the voltage of which is limited to the second clamp voltage (Vt) instead of the first clamp voltage (2Vt+Vr) as described above, is input to the PWM circuit 10. For this reason, the duty ratio of the switching transistor 2 becomes further smaller, and the rising speed of the output DC voltage Vo is further suppressed. As a result, the generation of overshoot is prevented. The output DC voltage Vo rises further to the second predetermined value (99% of the reference voltage). When the output DC voltage Vo rises above the second predetermined value (99% of the reference voltage) at time t2 in FIGS. 6A to 6G, the output signal V126 of the comparator 126 is inverted to L level. Hence, the output of the NAND circuit 123 becomes H level, and the transistor 124 is turned OFF. As a result, the limitation state in which the voltage of the second error signal Ve2 is limited to the second clamp voltage (Vt) is released, and the operation shifts to the normal operation in which the output DC voltage Vo is controlled to the reference voltage.

As described above, in the power supply according to the third embodiment, the second comparator circuit 9a is provided, and a judgment as to whether the output DC voltage Vo has reached the target value is made, whereby it becomes possible to set the limitation period using the second clamp voltage. Since the first clamp circuit 11 and the second clamp circuit 12 do not carry out clamp operation during the normal operation time, the output level (Ve) from the error amplifier 8 is equal to the input level (Ve2) to the PWM circuit 10.

### Fourth Embodiment

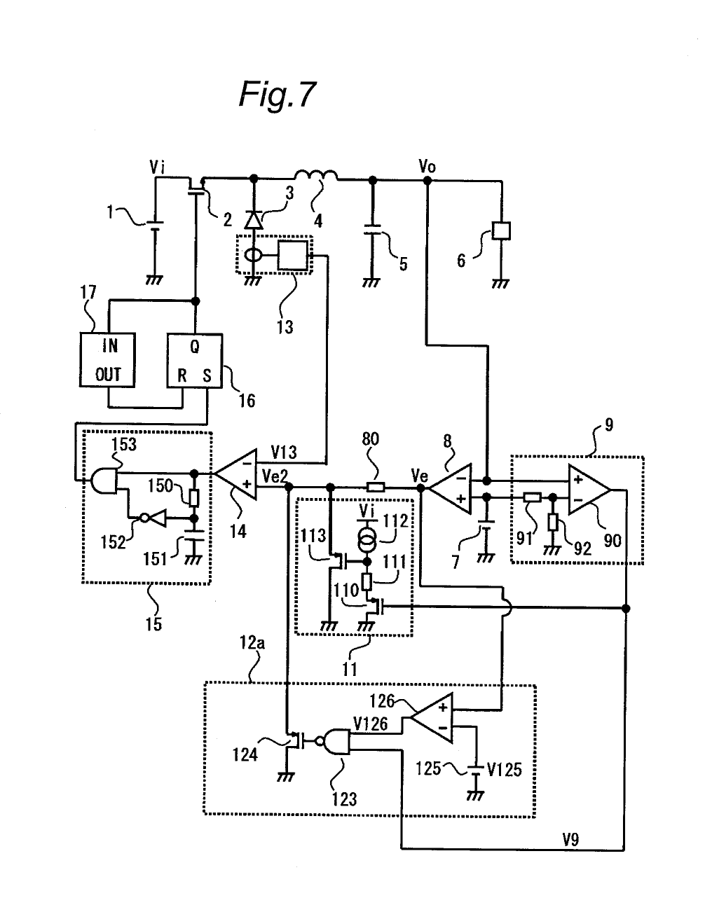

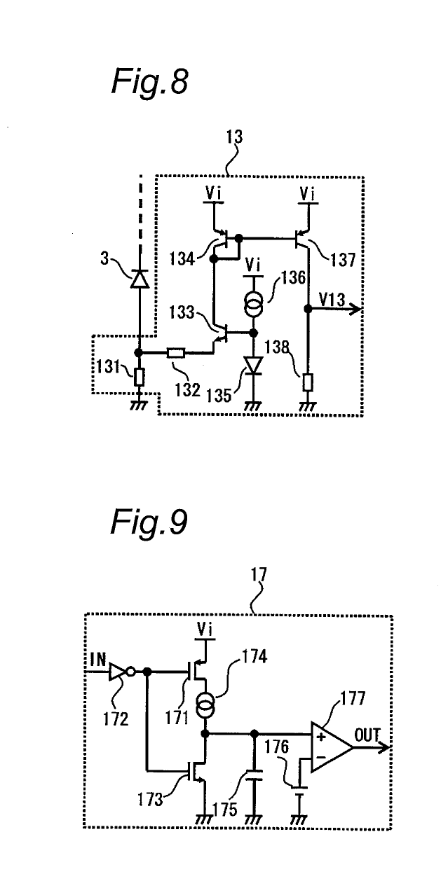

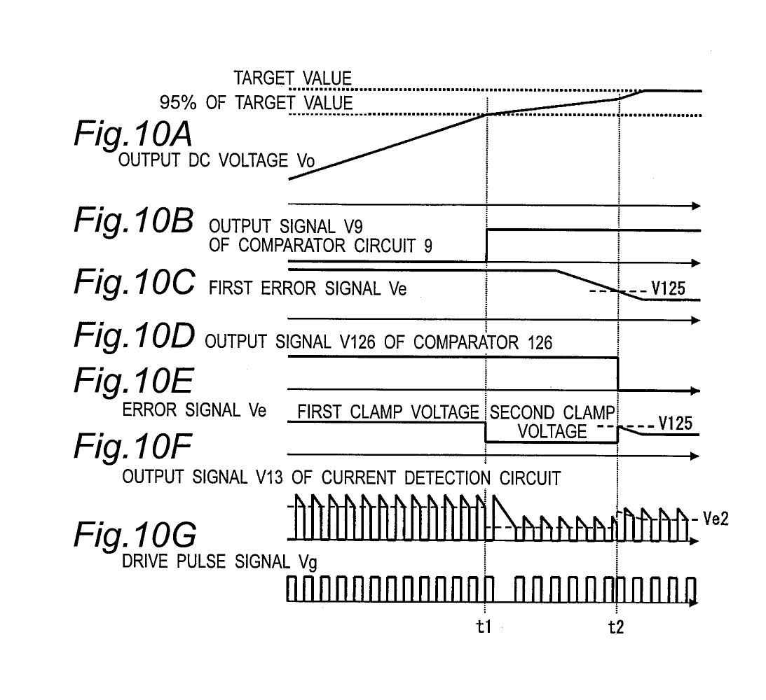

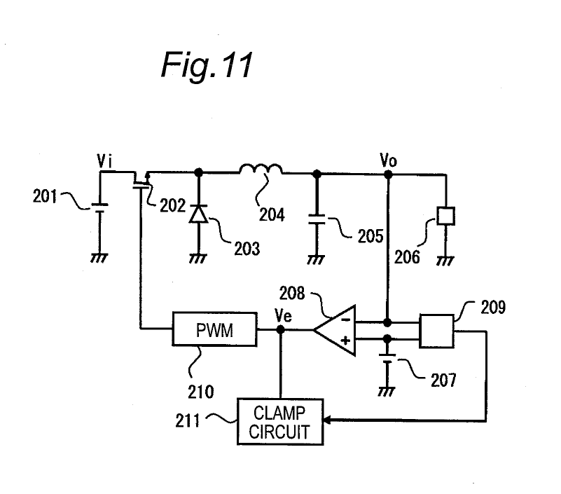

A power supply according to a fourth embodiment of the present invention will be described below referring to the accompanying FIGS. 7 to 10. FIG. 7 is a circuit diagram showing the configuration of the power supply according to the fourth embodiment of the present invention. FIGS. 8 and 9 are circuit diagrams showing an example of a current detection circuit and an example of a timer circuit in the power supply according to the fourth embodiment. FIGS. 10A to 10G are waveform diagrams showing the operations of various sections of the power supply shown in FIG. 7 at the start-up thereof. In the power supply according to the fourth embodiment, the components having the same functions and configurations as those of the above-mentioned power supplies according to the first to third embodiments are designated by the same numerals, and their descriptions are omitted. The power supply according to the fourth embodiment differs from the power supply according to the first embodiment in that a current detection circuit 13, a comparator 14, a pulse-forming circuit 15, an RS latch circuit 16 and a timer circuit 17 are provided and configured so as to set the operation timing of the switching transistor 2 and to drive the transistor according to the operation timing. In the power supply according to the fourth embodiment, a timing setting circuit comprising the comparator 14, the pulse-forming circuit 15, the RS latch circuit 16 and the timer circuit 17 is configured so as to set the operation timing of the switching transistor 2.

The power supplies according to the first to third embodiments according to the present invention employ voltage mode control in which the duty ratio of the switching transistor 2 is changed using the error signal Ve obtained by comparing the output DC voltage Vo with the reference voltage so that the output DC voltage Vo is controlled so as to become equal to the reference voltage. On the other hand, the power supply according to the fourth embodiment employs current mode control in which the error signal Ve obtained by comparing the output DC voltage Vo with the reference voltage is compared with a voltage V13 being proportional to the current flowing through the inductor 4, and the current flowing through the inductor 4 is adjusted so that the output DC voltage Vo is controlled so as to become equal to the reference voltage. In the fourth embodiment, the current flowing through the diode 3 is used instead of the current flowing through the inductor 4.

In the power supply according to the fourth embodiment, the voltage of the first error signal Ve generated by the error amplifier 8 rises when the output DC voltage Vo is lower than the reference voltage, and lowers when the output DC voltage Vo is higher than the reference voltage. During the normal operation time, the first clamp circuit 11 and the second clamp circuit 12 do not operate, and the first error signal Ve generated by the error amplifier 8 is input to the comparator 14 via the resistor 80.

As shown in FIG. 8, for example, the current detection circuit 13 comprises resistors 131, 132 and 138, a transistor 133, transistors 134 and 137 constituting a current mirror circuit, a constant current supply 136, and a diode 135, the forward voltage of which is equal to the base-emitter voltage of the transistor 133. Using the resistor 131 connected between the anode of the diode 3 and the ground, the current detection circuit 13 detects the current flowing through the diode 3, that is, the current flowing through the inductor 4 at the time when the switching transistor 2 is OFF, and then converts the current into a voltage and outputs the voltage. The output of the current detection circuit 13 and the output (the second error signal Ve2) derived from the error amplifier 8 via the resistor 80 are input to the comparator 14. When the output level of the current detection circuit 13 becomes lower than the output level (Ve2) derived from the error amplifier 8, the comparator 14 outputs an H-level signal. The pulse-forming circuit 15 comprises an integrating circuit comprising a resistor 150 and a capacitor 151 for integrating the output signal of the comparator 14, an inverter 152 and an AND circuit 153, and forms the H-level signal of the comparator 14 into a pulse signal and outputs the pulse signal.

As shown in FIG. 9, for example, the timer circuit 17 comprises an inverter 172, transistors 171 and 173, a constant current supply 174, a capacitor 175, a voltage supply 176 and a comparator 177. In the timer circuit 17, when an H-level signal is input to the inverter 172, the transistor 171 is turned ON, the capacitor 175 is begun to be charged at a constant current, and the voltage of the capacitor 175 rises. When the voltage of the capacitor 175 becomes higher than the voltage of the voltage supply 176, the comparator 177 outputs an H-level signal.

When the H-level signal is input from the pulse-forming circuit 15 to the set (S) terminal of the RS latch circuit 16, the RS latch circuit 16 outputs an H-level signal. When this H-level signal is input to the timer circuit 17, the timer circuit 17 outputs an H-level signal after the elapse of a predetermined time that is determined by the capacity of the capacitor 175, the constant current from the constant current supply 174 and the voltage of the voltage supply 176.

When the H-level signal of the timer circuit 17 is input to the reset (R) terminal of the RS latch circuit 16, the RS latch circuit 16 outputs an L-level signal. In other words, the ON period of the switching transistor 2 is set at a predetermined time using the pulse-forming circuit 15, the RS latch circuit 16 and the timer circuit 17.

Next, the operation of the power supply according to the fourth embodiment configured as described above will be described below.

First, the operation of the power supply according to the fourth embodiment during the normal operation time will be described below.

In the power supply according to the fourth embodiment, the voltage of the first error signal Ve generated by the error amplifier 8 rises when the output DC voltage Vo is lower than the reference voltage, and lowers when the output DC voltage Vo is higher than the reference voltage. Furthermore, the output of the current detection circuit 13 rises and lowers in proportion to the current flowing through the inductor 4. Hence, when the second error signal Ve2 derived from the first error signal Ve via the resistor 80 has a high potential, the comparator 14 outputs an H-level signal while a large amount of current flows through the inductor 4. On the other hand, when the second error signal Ve2 has a low potential, the comparator 14 outputs an H-level signal while a small amount of current flows through the inductor 4. When the comparator 14 outputs the H-level signal, the switching transistor 2 is turned ON, thereby increasing the current flowing through the inductor 4. As a result, the amount of the current flowing through the inductor 4 is proportional to the potential of the first error signal Ve. In other words, when the output DC voltage Vo is lower than the reference voltage, the voltage of the first error signal Ve rises, the current flowing through the inductor 4 becomes larger, and the output DC voltage Vo becomes higher. Conversely, when the output DC voltage Vo is higher than the reference voltage, the voltage of the first error signal Ve lowers, the current flowing through the inductor 4 becomes smaller, and the output DC voltage Vo becomes lower. This feedback operation controls the output DC voltage Vo so as to become equal to the reference voltage.

During the normal operation time, in the first clamp circuit 11, the transistor 110 of the first clamp circuit 11 is turned OFF using the H-level signal of the comparator circuit 9 that is input thereto. In addition, in the second clamp circuit 12a, since the voltage of the first error signal Ve is lower than the voltage V125 of the voltage supply 125, the output signal of the comparator 126 is L level. Furthermore, since the output of the comparator circuit 9 is H level, the NAND circuit 123 outputs an H-level signal, and the transistor 124 is turned OFF.

Next, the operation of the power supply at the start-up will be described below referring to FIGS. 10A to 10G. FIGS. 10A to 10G are waveform diagrams showing the operations of various sections of the power supply shown in FIG. 7 at the start-up.

FIG. 10A shows the waveform of the output DC voltage Vo, FIG. 10B shows the waveform of the output signal V9 of the comparator circuit 9, FIG. 10C shows the waveform of the first error signal Ve, FIG. 10D shows the waveform of the output signal 126 of the comparator 126, FIG. 10E shows the waveform of the second error signal Ve2 input to the comparator 14, FIG. 10F shows the waveform of the output signal V13 of the current detection circuit 13, and FIG. 10G shows the waveform of the drive pulse signal Vg output from the RS latch circuit 16 for driving the switching transistor 2.

At the start-up in which the output DC voltage Vo does not reach the predetermined value (95% of the reference voltage), the first error signal Ve generated by the error amplifier 8 has a high potential, and the output signal V9 of the comparator circuit 9 is L level. Hence, the voltage of the second error signal Ve2 that is input to the comparator 14 is limited to the addition voltage (2Vt+Vr) of the source-gate voltage Vt of the transistor 110, the voltage Vr across the resistor 111 and the source-gate voltage Vt of the transistor 113 of the first clamp circuit 11. Hence, the current of the inductor 4 is limited. As a result, the generation of inrush current can be prevented in the power supply according to the fourth embodiment. During this period, in the second clamp circuit 12a, since the voltage of the second error signal Ve is higher than the voltage V125 of the voltage supply 125, the output signal V126 of the comparator 126 is H level, and the output signal V9 of the comparator circuit 9 is L level. Hence, the NAND circuit 123 outputs an H-level signal, and the transistor 124 is turned OFF.

When the output DC voltage Vo reaches the predetermined value (95% of the reference voltage) at time t1 in FIGS. 10A to 10G, the output signal V9 of the comparator circuit 9 becomes H level, and the clamp limitation using the first clamp circuit 11 is released. At the same time, in the second clamp circuit 12a, since the comparator 126 outputs an H-level signal and the output signal V9 of the comparator circuit 9 becomes H level, the output of the NAND circuit 123 becomes L level. As a result, the transistor 124 is turned ON, and the voltage of the second error signal Ve2 is limited to the source-gate voltage Vt of the transistor 124. Since the second error signal Ve2, the voltage of which limited to the second clamp voltage (Vt) instead of the first clamp voltage (2Vt+Vr), is input to the comparator 14, the current flowing through the inductor 4 is limited so as to become further smaller, the rising speed of the output DC voltage Vo is further suppressed, and the generation of overshoot is prevented. The output DC voltage Vo soon reaches the reference voltage of the reference voltage supply 7, that is, the target value, and the voltage of the first error signal Ve lowers. On the premise that the load 6 at the start-up is light, the voltage of the first error signal Ve lowers to a level lower than the voltage V125 of the voltage supply 125. When the voltage of the first error signal Ve lowers to a level lower than the voltage V125 of the voltage supply 125 at time t2 in FIGS. 10A to 10G, the output signal V126 of the comparator 126 is inverted to L level. As a result, the output of the NAND circuit 123 becomes H level, and the transistor 124 is turned OFF. When the transistor 124 is turned OFF, the limitation of the voltage of the first error signal Ve to the second clamp voltage (Vt) is released, and the operation shifts to the normal operation in which the output DC voltage Vo is controlled to the reference voltage.

As described above, even in the power supply according to the fourth embodiment employing the current mode control, the supply power is limited immediately before the output DC voltage reaches the target value, whereby the output overshoot under light load at the start-up can be suppressed. In the case of the current mode control, since the error signal to be limited directly corresponds to the current flowing through the inductor 4, that is, the current supplied to the output, the power supply has excellent characteristics capable of setting the suppression level of inrush current and capable of speedily responding to transient phenomena, such as output overshoot.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

The present invention is thus useful for a power supply to which a DC voltage is input from a DC power supply, such as a battery, and from which a controlled DC voltage is output.

What is claimed is:

1. A power supply, for converting an input DC voltage into an output DC voltage and supplying power to a load, comprising:
an error amplifier for outputting an error signal corresponding to the error between said output DC voltage and the target value thereof,
a control section for adjusting power to be supplied to said load on the basis of said error signal, and
a limiting circuit for limiting the voltage of said error signal to a predetermined level for a predetermined time after said output DC voltage at the start-up exceeds a predetermined value being set less than said target value.

2. The power supply according to claim 1, wherein said limiting circuit limits the voltage of said error signal to a first predetermined level until said output DC voltage at the start-up reaches said predetermined value being set less than said target value, and limits the voltage of said error signal to a second predetermined level for a predetermined time after said output DC voltage at the start-up exceeds said predetermined value being set less than said target value.

3. The power supply according to claim 2, wherein said limiting circuit comprises a comparator circuit for comparing said output DC voltage with said predetermined value being set less than the target value; a first clamp circuit for limiting the voltage of said error signal to a first predetermined level on the basis of the output of said comparator circuit until said output DC voltage at the start-up reaches said predetermined value being set less than said target value; and a second clamp circuit for limiting the voltage of said error signal to a second predetermined level for a predetermined time on the basis of the output of said comparator circuit after said output DC voltage at the start-up exceeds said predetermined value being set less than said target value.

4. The power supply according to claim 3, wherein said second clamp circuit limits the voltage of said error signal to a second predetermined level on the basis of the output of said comparator circuit for a predetermined time after said output DC voltage at the start-up exceeds said predetermined value being set less than said target value, and releases the limitation to said second predetermined level when the error between said output DC voltage at the start-up and said target value becomes a reference voltage or less.

5. The power supply according to claim 2, wherein said limiting circuit comprises a first comparator circuit for comparing said output DC voltage with a first value being set less than said target value; a second comparator circuit for comparing said output DC voltage with a second value that is set less than the target value and higher than said first value; a first clamp circuit for limiting the voltage of said error signal to a first predetermined level on the basis of the output of said first comparator circuit until said output DC voltage at the start-up reaches said first value being set less than said target value; and a second clamp circuit for limiting the voltage of said error signal to a second predetermined level for a predetermined time on the basis of the output of said first comparator circuit after said output DC voltage at the start-up exceeds said first value being set less than said target value, and releasing the limitation to said second predetermined level on the basis of the output of said second comparator circuit.

6. The power supply according to claim 1, wherein said predetermined time is set at a period elapsed after said output DC voltage exceeds said predetermined value being set less than the target value and until said output DC voltage reaches said target value.

7. The power supply according to claim 2, wherein said predetermined time is set at a period elapsed after said output DC voltage exceeds said predetermined value being set less than the target value and until said output DC voltage reaches said target value.

8. The power supply according to claim 1, wherein said control section comprises a voltage conversion section having a switch, a rectifier and an inductor, and a PWM circuit for ON/OFF controlling said switch according to said error signal.

9. The power supply according to claim 1, wherein said limiting circuit limits the voltage of said error signal to a first predetermined level until said output DC voltage at the start-up reaches said predetermined value being set less than said target value, and limits the voltage of said error signal to a second predetermined level for a predetermined time after said output DC voltage at the start-up exceeds said predetermined value being set less than said target value, and
said control section comprises a voltage conversion section having a switch, a rectifier and an inductor, and a PWM circuit for ON/OFF controlling said switch according to said error signal.

10. The power supply according to claim 2, wherein
said limiting circuit comprises a comparator circuit for comparing said output DC voltage with said predetermined value being set less than the target value; a first clamp circuit for limiting the voltage of said error signal to a first predetermined level on the basis of the output of said comparator circuit until said output DC voltage at the start-up reaches said predetermined value being set less than said target value; and a second clamp circuit for limiting the voltage of said error signal to a second predetermined level for a predetermined time on the basis of the output of said comparator circuit after said output DC voltage at the start-up exceeds said predetermined value being set less than said target value, and
said control section comprises a voltage conversion section having a switch, a rectifier and an inductor, and a PWM circuit for ON/OFF controlling said switch according to said error signal.

11. The power supply according to claim 3, wherein said second clamp circuit limits the voltage of said error signal to a second predetermined level on the basis of the output of said comparator circuit for a predetermined time after said output DC voltage at the start-up exceeds said predetermined value being set less than said target value, and releases the limitation to said second predetermined level when the error between said output DC voltage at the start-up and said target value becomes a reference voltage or less, and
said control section comprises a voltage conversion section having a switch, a rectifier and an inductor, and a PWM circuit for ON/OFF controlling said switch according to said error signal.

12. The power supply according to claim 2, wherein
said limiting circuit comprises a first comparator circuit for comparing said output DC voltage with a first value being set less than said target value; a second comparator circuit for comparing said output DC voltage with a second value that is set less than the target value and higher than said first value; a first clamp circuit for limiting the voltage of said error signal to a first predetermined level on the basis of the output of said first comparator circuit until said output DC voltage at the start-up reaches said first value being set less than said target value; and a second clamp circuit for limiting the voltage of said error signal to a second predetermined level for a predetermined time on the basis of the output of said first comparator circuit after said output DC voltage at the start-up exceeds said first value being set less than said target value, and releasing the limitation to said second predetermined level on the basis of the output of said second comparator circuit, and
said control section comprises a voltage conversion section having a switch, a rectifier and an inductor, and a PWM circuit for ON/OFF controlling said switch according to said error signal.

13. The power supply according to claim 1, wherein
said control section comprises a voltage conversion section having a switch, a rectifier and an inductor, and a PWM circuit for ON/OFF controlling said switch according to said error signal, and
said PWM circuit comprises a current detector for detecting the current flowing through said voltage conversion section, and a timing setting circuit for setting the ON/OFF timing of said switch on the basis of the output of said current detector and said error signal.

14. The power supply according to claim 1, wherein
said limiting circuit limits the voltage of said error signal to a first predetermined level until said output DC voltage at the start-up reaches said predetermined value being set less than said target value, and limits the voltage of said error signal to a second predetermined level for a predetermined time after said output DC voltage at the start-up exceeds said predetermined value being set less than said target value,
said control section comprises a voltage conversion section having a switch, a rectifier and an inductor, and a PWM circuit for ON/OFF controlling said switch according to said error signal, and
said PWM circuit comprises a current detector for detecting the current flowing through said voltage conversion section, and a timing setting circuit for setting the ON/OFF timing of said switch on the basis of the output of said current detector and said error signal.

15. The power supply according to claim 2, wherein said limiting circuit comprises a comparator circuit for comparing said output DC voltage with said predetermined value being set less than the target value; a first clamp circuit for limiting the voltage of said error signal to a first predetermined level on the basis of the output of said comparator circuit until said output DC voltage at the start-up reaches said predetermined value being set less than said target value; and a second clamp circuit for limiting the voltage of said error signal to a second predetermined level for a predetermined time on the basis of the output of said comparator circuit after said output DC voltage at the start-up exceeds said predetermined value being set less than said target value,
said control section comprises a voltage conversion section having a switch, a rectifier and an inductor, and a PWM circuit for ON/OFF controlling said switch according to said error signal, and
said PWM circuit comprises a current detector for detecting the current flowing through said voltage conversion section, and a timing setting circuit for setting the ON/OFF timing of said switch on the basis of the output of said current detector and said error signal.

16. The power supply according to claim 3, wherein
said second clamp circuit limits the voltage of said error signal to a second predetermined level on the basis of the output of said comparator circuit for a predetermined time after said output DC voltage at the start-up exceeds said predetermined value being set less than said target value, and releases the limitation to said second predetermined level when the error between said output DC voltage at the start-up and said target value becomes a reference voltage or less,
said control section comprises a voltage conversion section having a switch, a rectifier and an inductor, and a PWM circuit for ON/OFF controlling said switch according to said error signal, and
said PWM circuit comprises a current detector for detecting the current flowing through said voltage conversion section, and a timing setting circuit for setting the ON/OFF timing of said switch on the basis of the output of said current detector and said error signal.

17. The power supply according to claim 2, wherein
said limiting circuit comprises a first comparator circuit for comparing said output DC voltage with a first value being set less than said target value; a second comparator circuit for comparing said output DC voltage with a second value that is set less than the target value and higher than said first value; a first clamp circuit for limiting the voltage of said error signal to a first predetermined level on the basis of the output of said first comparator circuit until said output DC voltage at the start-up reaches said first value being set less than said target value; and a second clamp circuit for limiting the voltage of said error signal to a second predetermined level for a predetermined time on the basis of the output of said first comparator circuit after said output DC voltage at the start-up exceeds said first value being set less than said target value, and releasing the limitation to said second predetermined level on the basis of the output of said second comparator circuit,
said control section comprises a voltage conversion section having a switch, a rectifier and an inductor, and a PWM circuit for ON/OFF controlling said switch according to said error signal, and
said PWM circuit comprises a current detector for detecting the current flowing through said voltage conversion section, and a timing setting circuit for setting the ON/OFF timing of said switch on the basis of the output of said current detector and said error signal.
